(19) United States
(12) Patent Application Publication
(10) Pub. No.: US 2024/0340765 A1
(43) Pub. Date: Oct. 10, 2024

(54) SYSTEMS AND METHODS FOR MAINTAINING SERVICE SESSION CONTINUITY IN A WIRELESS COMMUNICATION NETWORK

(71) Applicant: Samsung Electronics Co., Ltd., Suwon-si (KR)

(72) Inventors: Jagadeesh GANDIKOTA, Bangalore (IN); Sambhavesh HARALALKA, Bangalore (IN); Lalith KUMAR, Bangalore (IN); Danish Ehsan HASHMI, Bangalore (IN); Koustav ROY, Bangalore (IN)

(21) Appl. No.: 18/746,968

(22) Filed: Jun. 18, 2024

Related U.S. Application Data
(63) Continuation of application No. PCT/KR2024/002600, filed on Feb. 28, 2024.

(30) Foreign Application Priority Data
Mar. 2, 2023 (IN) 202341014247
Feb. 21, 2024 (IN) 2023 41014247

(51) Int. Cl. H04W 40/22; H04W 4/90; H04W 40/12

(52) U.S. Cl. CPC H04W 40/22; H04W 4/90; H04W 40/12

(57) ABSTRACT

A user equipment (UE) and a method to maintain service session continuity in a wireless communication network are provided. The UE includes a transceiver, memory storing one or more computer programs, and one or more processors communicatively coupled to the transceiver and the memory, wherein the one or more computer programs include computer-executable instructions that, when executed by the one or more processors, cause the UE to identify an application running on the UE and a corresponding packet data unit (PDU) session mapping for the application data route, defer a re-evaluation of UE route selection policy (URSP), until at least one condition has been met, based on an application type, and trigger the re-evaluation and applying highest priority URSP rules for traffic for the identified application during an ongoing service session based on the application type.

### CROSS-REFERENCE TO RELATED APPLICATION(S)

This application is a continuation application, claiming priority under § 365 (c), of an International application No. PCT/KR2024/002600, filed on Feb. 28, 2024, which is based on and claims the benefit of an Indian Provisional patent application No. 202341014247, filed on Mar. 2, 2023, in the Indian Intellectual Property Office, and of an Indian Complete patent application Ser. No. 202341014247, filed on Feb. 21, 2024, in the Indian Intellectual Property Office, the disclosure of each of which is incorporated by reference herein in its entirety.

### BACKGROUND

### 1. Field

The disclosure relates to wireless communication networks. More particularly, the disclosure relates to systems and methods for maintaining service session continuity in a wireless communication network.

### 2. Description of Related Art

Typically, user equipment (UE) route selection policy (URSP) in a fifth generation (5G) mobile network system involves the selection of the optimal data path or route for user data traffic between the UE, and the external data network (DN) through the 5G core network (5GC). The URSP plays a crucial role in determining the transmission, and routing of user data through the network. The URSP rules ensure efficient and reliable data delivery. In a 5G Standalone mode, the URSP is a way by which application traffic will be routed via a packet data unit (PDU) Session.

In a scenario, the UE may already have an ongoing voice or video call over a PDU Session (for example, PDU Session 1 having Slice 1, data network name (DNN) 1) at a particular time. The network updates the URSP rule at the same time, which causes the UE to route the ongoing voice or video call traffic over a new PDU session (e.g., PDU session 2 having slice 2, DNN 2). However, routing the voice call or the video call over the new PDU session may drop the ongoing voice or video call. Therefore, the voice or video call continuity may be disrupted, if the UE performs re-evaluation of URSP rule at the time of an ongoing voice or video call.

In another case, if the UE is running an application (for example, an online streaming app) and the network updates the URSP rules (for example, when the user subscribes for a higher version slice for the online streaming app). In this case, if the UE does not re-evaluate the URSP rule and continues using the old PDU Session which is associated with the old slice. Thereafter, the UE may not able to enjoy a higher priority slice or service, and may be stuck with a low quality video. Therefore, it is important for the UE to decide selective URSP rule evaluation, and determine the right trigger to re-evaluate URSP rules based on service or application type.

FIG. 1 illustrates a scenario 100 wherein an ongoing call is dropped, when a URSP rule is updated according to the related art.

Referring to FIG. 1, at operation 1, the UE may have an ongoing voice call or a video call. At operation 2, the network updates the URSP rules for the service. At operation 3, the UE re-evaluates and establishes a new PDU Session and releases an old PDU Session. At operation 4, as the URSP rules are being re-evaluated during an ongoing service session, the voice call or video call gets dropped.

FIG. 2 illustrates a scenario 200, for a call, such as an information management system (IMS), emergency call, and like is dropped, due to URSP rule re-evaluation according to the related art. Consider that the UE is currently using an IMS application for a voice or video call.

Referring to FIG. 2, at operation 202, the UE checks whether the URSP re-evaluation criteria has been met. At operation 204, if the URSP re-evaluation criteria has not been met, the UE shall continue the service on the existing PDU session. At operation 206, the UE checks if the URSP rule evaluation criteria has been met, and if the currently used route selection descriptor (RSD) or PDU session does not have the highest priority rule, then the UE will re-evaluate the URSP rule configured in the UE again. In this condition, if the UE finds any RSD having higher priority than the current RSD at operation 206, the UE releases the existing PDU session for the application and establish a new PDU session with the highest priority RSD at operation 208. In this scenario, at operation 210, an ongoing voice or video call will get dropped as the existing PDU session has been released by the Network. The Network re-evaluates the URSP rule whenever the re-evaluation criteria has been met, then the UE may not be able to utilize the best service possible.

TABLE 1
OLD URSP Rule

| | |
|---|---|
| Rule Priority | 1 |
| TD | App ID-1 |
| RSD | RSD-1: S-NSSAI-1, DNN-1, Priority-1 |

TABLE 2
Updated URSP Rule

| | |
|---|---|
| Rule Priority | 1 |
| TD | App ID-1 |
| RSD | RSD-2: S-NSSAI-2, DNN-2, Priority-1 |
| | RSD-1: S-NSSAI-1, DNN-1, Priority-2 |

According to third generation partnership project (3GPP) standards, the UE 102 may re-evaluate the URSP rule, when the network updates URSP rules due to subscription changes. As per the depicted example in Table 1 for the old URSP rule, the UE 102 has only one RSD, i.e., RSD-1 for App ID-1. Now for example, App ID-1 is for the IMS application and the IMS application triggers a call. During the call, if the network sends a new URSP rule, as per updated URSP rule, the UE 102 should prioritize RSD-2 over RSD-1. In this condition, if the UE 102 re-evaluates the URSP rule, the UE 102 may release the ongoing PDU session and establish a new PDU session as per RSD-2 defined attributes in Table 2. In this condition, the ongoing voice call will get dropped. The above scenario can also be true for all session sensitive applications (such as, but not limited to, voice calls, video calls, emergency calls, transaction activities (e.g., banking transaction sessions), UE 102 controlled robots, and so on).

FIG. 3 is a sequence diagram 300 depicting a call (such as an IMS, emergency call, and so on) being dropped, due to updating the URSP rule according to the related art. For example, the URSP rule has been configured as follows:
Rule priority: 1,
Traffic descriptor: App ID-1, and
Route selection descriptor: RSD-1: Priority-1, DNN-1, Slice-1.

Referring to FIG. 3, at operation 302, the UE 102 establishes a PDU session ID 1 using RSD-1 for a voice, video, and emergency call using App ID-1. At operation 304, the network updates the existing URSP rule and overrides the URSP rule as below:
Network configured URSP rule:
Rule priority: 1
Traffic descriptor: App ID-1
Route selection descriptor:
RSD-2: Priority-1, DNN-1, Slice-2
RSD-1: Priority-2, DNN-1, Slice-1.

At operation 306, the UE 102 re-evaluates the URSP rule. The UE 102 determines that the RSD-2 has a higher priority than the RSD-1. At operation 308, the UE 102 therefore releases PDU Session 1, and the voice call, the video call, emergency call is dropped at this point. At operation 310, the UE 102 sends a PDU session establishment request using RSD-2 parameters to the network for App ID-1. Therefore, the ongoing service gets interrupted in between, if the URSP rule gets re-evaluated in the middle of the ongoing service, when a higher priority URSP rule becomes available.

FIG. 4 is a sequence diagram 400 depicting a call being dropped, due to a change in local area data network (LADN) service area according to the related art. For example, the URSP rule has been configured as follows:
Rule priority: 1,
Traffic descriptor: App ID-1, and
Route selection descriptor:
RSD-1: Priority-1, LADN DNN-1, Slice-1, and
RSD-2: Priority-2, DNN-2, Slice-2.

For example, referring to FIG. 4, at operation 402, consider that the UE 102 is outside the LADN Service Area and starts using App ID-1. At operation 404, the UE 102 establishes a PDU Session 2 using RSD-2 for voice/video/emergency calls using App ID-1, outside the LADN area. At operation 406, the UE 102 enters into the LADN service area. At operation 408, the UE 102 checks for an updated URSP. Consider that the UE 102 finds RSD-1 with the updated URSP rule and determines that RSD-1 has a higher priority than RSD-2. At operation 410, the UE 102 releases the PDU Session 2, and the call or the service gets dropped as soon as the PDU session has been released. At operation 412, the UE 102 sends the PDU session establishment request using RSD-1 parameters to the network for App ID-1. Therefore, the call or the on-going service gets dropped due to the change in LADN area.

FIG. 5 is a sequence diagram 500 depicting quality of service (QOS) being downgraded, due to URSP rule re-evaluation according to the related art. For example, consider that the URSP rule has been configured as follows:
Rule priority: 1,
Traffic descriptor: App ID-1, and
Route selection descriptor:
RSD-1: Priority-1, DNN-1, Slice-1

Referring to FIG. 5, at operation 502, the UE 102 establishes a PDU session ID 1 using RSD-1 for voice, video, and emergency calls using App ID-1. At operation 504, the network updates the existing URSP rule and overrides the URSP rule by configuring the URSP rule as below:
Rule priority: 1
Traffic descriptor: App ID-1
Route selection descriptor:
RSD-2: Priority-1, DNN-1, Slice-2
RSD-1: Priority-2, DNN-1, Slice-1

The RSD-2 parameters provide a lower QoS (i.e., slice-2 is a lower quality slice), and RSD-1 parameters provides a higher QoS (i.e., slice-1 is a higher quality slice). At operation 506, the UE 102 re-evaluates the URSP rule. The UE 102 determines that the RSD-2 has a higher priority than RSD-1. At operation 508, the UE 102 releases the PDU Session 1 on RSD-1. At operation 510, the UE 102 sends the PDU Session establishment request using the RSD-2 parameters to the network for App ID-1. A network function (NF) sends a PDU session establishment accept using RSD-2 parameters (i.e., DNN-1, Slice-2). Thereafter, a PDU session using RSD-2 parameters is established using App ID-1. As the RSD-2 provides a lower quality of service (as it has a lower quality of slice), the quality of service drops from a higher quality to a lower quality of service after the URSP re-evaluation. Therefore, QoS for App ID-1 is degraded. The QoS may be degraded by network for all kind of applications.

FIG. 6 is a sequence diagram 600 depicting re-evaluation of a URSP rule being deferred, which may lead to disruption in a QoS according to the related art. For example, considering that the URSP rule has been configured as follows:
Rule priority: 1
Traffic descriptor: App ID-1
Route selection descriptor:
RSD-1: Priority-1, LADN DNN-1, Slice-1
RSD-2: Priority-2, DNN-2, Slice-2

Considering the UE 102 is outside the LADN service area and the UE starts using an application.

Referring to FIG. 6, at operation 602, the UE 102 establishes the PDU session 2 using RSD-2 for the application id. At operation 604, the UE 102 enters into the LADN service area. At operation 606, the UE 102 defers re-evaluation of the URSP rule, until the UE 102 goes to enterprise mobility management (EMM) idle mode, or the current data session is over. The UE 102 (which is in EMM-IDLE state) does not have a signaling connection to the mobility management entity (MME). At operation 608, the UE 102 continues using PDU Session ID 2. At operation 610, the UE 102 is not able to utilize LADN services, even when it is inside the LADN service area.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for maintaining service session continuity in a wireless communication network.

Another aspect of the disclosure is to provide methods and systems for evaluating user equipment (UE) route selection policy (URSP) in wireless communication networks.

Another aspect of the disclosure is to provide methods and systems for establishing higher quality, higher bandwidth and lower latency data path in wireless communication networks, wherever applicable.

Another aspect of the disclosure is to provide methods and systems for identifying the kind of application running on the device and corresponding PDU session mapping for an application data route.

Another aspect of the disclosure is to provide methods and systems for deferring re-evaluation of the URSP until a current service session is over based on application type, and triggering URSP re-evaluation only after the current service session is over.

Another aspect of the disclosure is to provide methods and systems for triggering re-evaluation and applying highest priority URSP rules for the current application traffic during an ongoing data session based on the application type guaranteed to provide best service availability.

Additional aspects will be set forth in part in the description which follows and, in part, will be apparent from the description, or may be learned by practice of the presented embodiments.

In accordance with an aspect of the disclosure, methods and systems to maintain service session continuity in a wireless communication network are provided. The method includes identifying, by a user equipment (UE), an application running on the UE and a corresponding packet data unit (PDU) session mapping for an application data route. The method further includes deferring, by the UE, re-evaluation of UE route selection policy (URSP), until at least one condition has been met, based on an application type. The method further includes triggering, by the UE, re-evaluation and applying top priority URSP rules for traffic, for the identified application, based on the application type.

In accordance with another aspect of the disclosure, a user equipment (UE) in a wireless communication system is provided. The UE includes a transceiver, memory storing one or more computer programs, and one or more processors communicatively coupled to the transceiver and the memory, wherein the one or more computer programs include computer-executable instructions that, when executed by the one or more processors, cause the UE to identify an application running on the UE and a corresponding packet data unit (PDU) session mapping for an application data route, defer a re-evaluation of UE route selection policy (URSP), until at least one condition has been met, based on an application type, and trigger the re-evaluation and applying highest priority URSP rules for traffic for the identified application during an ongoing service session based on the application type.

In accordance with another aspect of the disclosure, a method to maintain a service session continuity in a wireless communication system is provided. The method includes identifying, by the UE, an application type and a corresponding packet data unit (PDU) session mapping for an application data route for an application running on the UE, deferring, by the UE, URSP re-evaluation until at least one of a condition to initiate the URSP re-evaluation has been met, and triggering, by the UE, the URSP re-evaluation, based on the identified application type for the application running on the UE.

In accordance with another aspect of the disclosure, a UE in a wireless communication system is provided. The UE includes a transceiver, memory storing one or more computer programs, and one or more processors communicatively coupled with the transceiver and the memory, wherein the one or more computer programs include computer-executable instructions that, when executed by the one or more processors, cause the UE to identify an application type and a corresponding packet data unit (PDU) session mapping for an application data route for an application running on the UE, defer URSP re-evaluation until at least one of a condition to initiate the URSP re-evaluation has been met, and trigger, by the UE, the URSP re-evaluation, based on the identified application type for the application running on the UE.

In accordance with another aspect of the disclosure, one or more non-transitory computer-readable storage media storing computer-executable instructions that, when executed by one or more processors of a UE, cause the UE to perform operations are provided. The operations include identifying, by the UE, an application running on the UE and a corresponding PDU session mapping for an application data route, deferring, by the UE, re-evaluation of UE URSP, until at least one condition has been met, based on an application type, and triggering, by the UE, re-evaluation and applying highest priority URSP rules for traffic, for the identified application, based on the application type.

In accordance with another aspect of the disclosure, a method to maintain service session continuity in a wireless communication network is provided. The method comprises identifying, by a user equipment (UE), an application running on the UE and a corresponding packet data unit (PDU) session for an application data route; deferring, by the UE, re-evaluation of one or more UE route selection policy (URSP) rules, until at least one condition has been met, based on an application type of the application; and triggering, by the UE, the re-evaluation of one or more URSP rules and applying a highest priority URSP rule for traffic for the identified application.

In accordance with another aspect of the disclosure, a user equipment (UE) in a wireless communication system is provided. The UE comprises one or more processors; and memory storing one or more instructions that, when executed by the one or more processors, cause the UE to identify an application running on the UE and a corresponding packet data unit (PDU) session for an application data route, defer a re-evaluation of one or more UE route selection policy (URSP) rules, until at least one condition has been met, based on an application type of the application, and trigger the re-evaluation of one or more URSP rules and applying a highest priority URSP rule for traffic for the identified application.

In accordance with another aspect of the disclosure, one or more non-transitory computer-readable storage media storing computer-executable instructions that, when executed by one or more processors of a user equipment (UE), cause the UE to perform operations is provided. The operations comprises identifying, by a user equipment (UE), an application running on the UE and a corresponding packet data unit (PDU) session for an application data route; deferring, by the UE, re-evaluation of one or more UE route selection policy (URSP) rules, until at least one condition has been met, based on an application type of the application; and triggering, by the UE, the re-evaluation of one or more URSP rules and applying a highest priority URSP rule for traffic to the identified application.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 depicts a scenario, wherein an ongoing call is dropped, when a route selection policy (URSP) rule is updated, according to the related art;

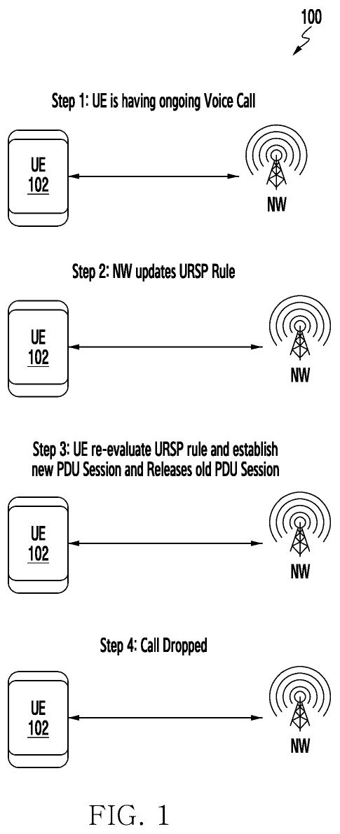

FIG. 2 depicts a scenario, for a call, such as an information management system (IMS), emergency call, and alike is dropped, due to URSP rule re-evaluation, according to the related art;

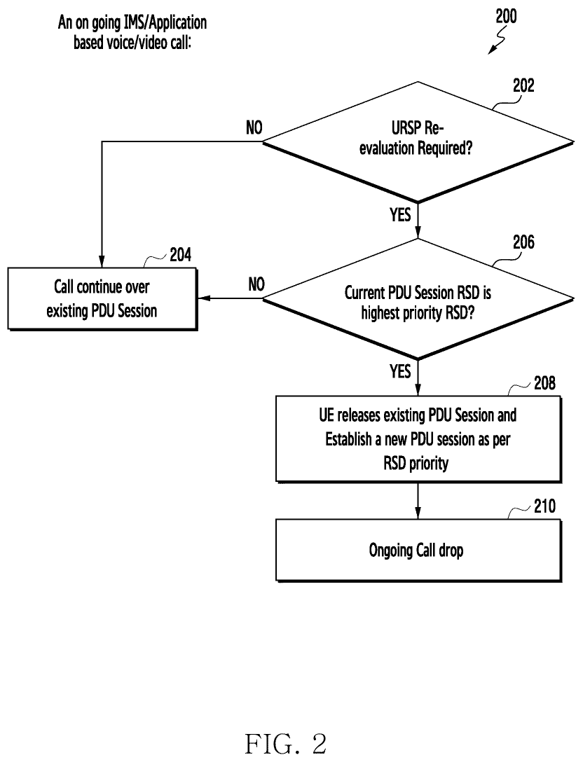

FIG. 3 is a sequence diagram depicting a call (such as an IMS, emergency call, and so on) being dropped, due to updating of a URSP rule according to the related art;

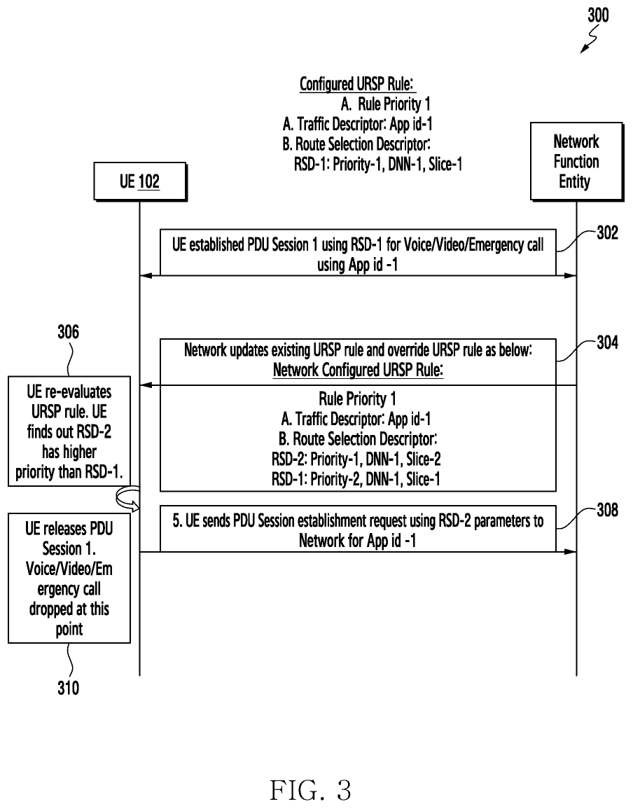

FIG. 4 is a sequence diagram depicting a call being dropped, due to a change in local area data network (LADN) service area according to the related art;

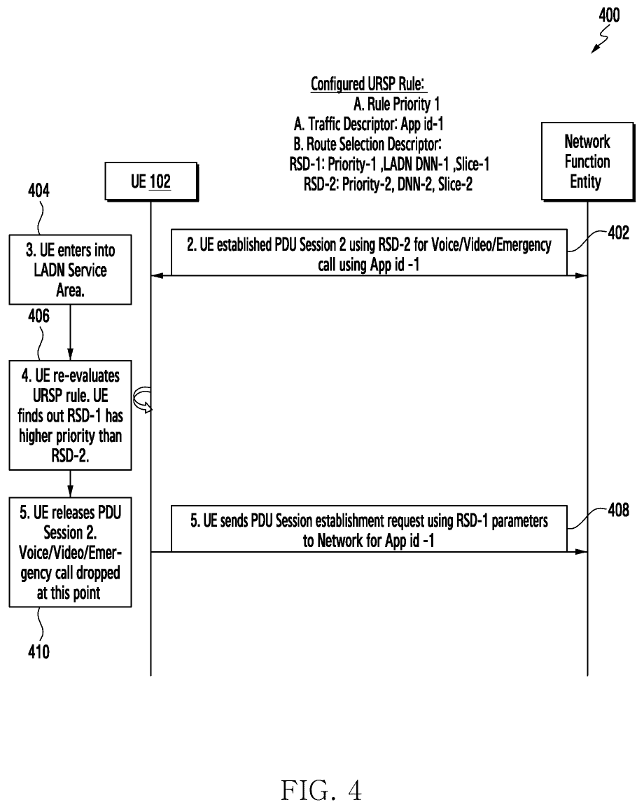

FIG. 5 is a sequence diagram depicting a quality of service (QOS) being downgraded, due to URSP rule re-evaluation according to the related art;

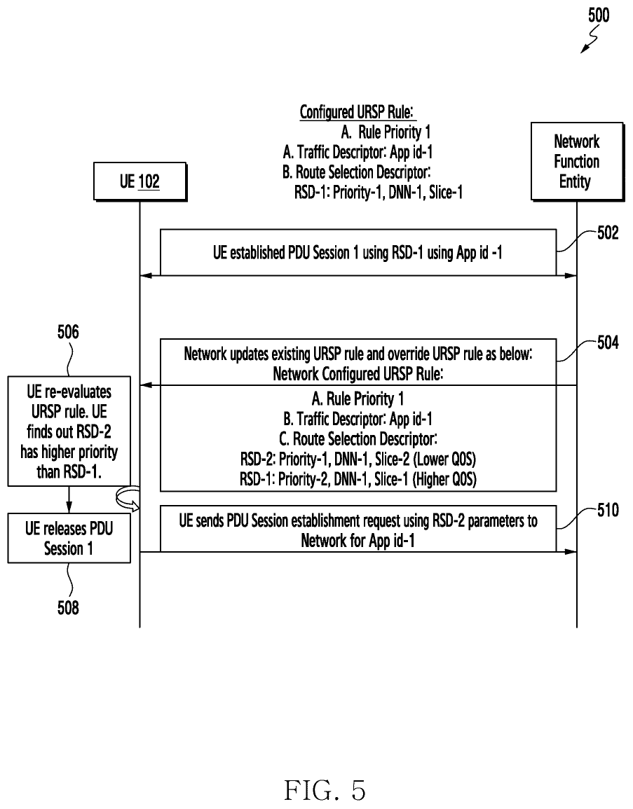

FIG. 6 is a sequence diagram depicting a re-evaluation of a URSP rule being deferred, which may lead to disruption in a QoS according to the related art;

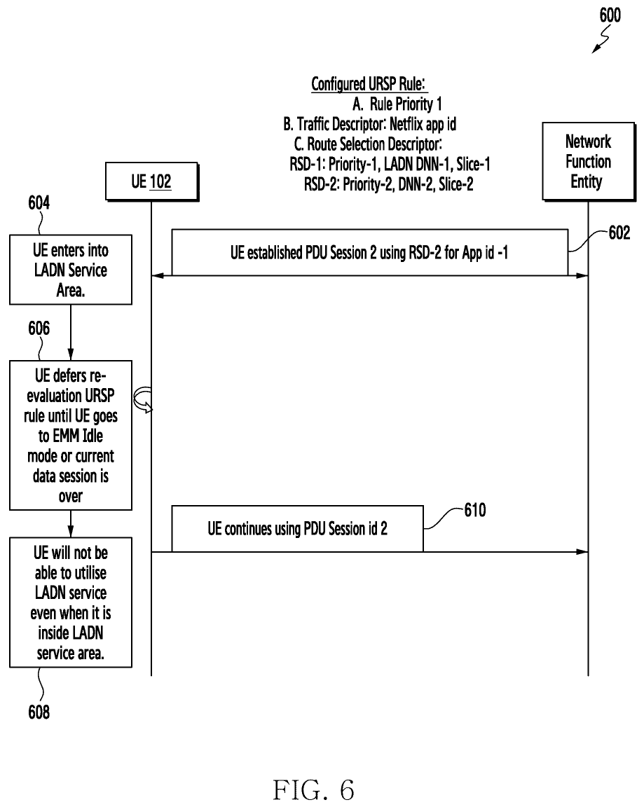

FIG. 7 shows a schematic diagram showing identification of an application type of an application running on a user equipment (UE) according to an embodiment of the disclosure;

FIG. 8A depicts a method for re-evaluating URSP rules for session critical applications, after a session is over, according to an embodiment of the disclosure;

FIG. 8B depicts a sequence diagram for re-evaluating URSP rules for session critical applications, after a session is over, according to an embodiment of the disclosure;

FIG. 9 depicts a method for re-evaluating URSP rules for session critical applications, after a PDU session has been released, according to an embodiment of the disclosure;

FIG. 10 depicts a method for re-evaluating URSP rules for session critical applications, after a UE has moved to an idle state, according to an embodiment of the disclosure;

FIG. 11 depicts a method for re-evaluating URSP rules for session critical applications, after a timer expires, according to an embodiment of the disclosure;

FIG. 12A depicts a method for re-evaluating URSP rules for data critical applications, according to an embodiment of the disclosure;

FIG. 12B depicts a sequence diagram for re-evaluating URSP rules for data critical applications, according to an embodiment of the disclosure; and

FIG. 13 depicts a scenario showing a UE determining a quality of service (QOS) for each URSP rule is identified and execution of an URSP rule, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “example”, “illustration”. “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports, such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by symbols of the related art, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by symbols of the related art, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words, such as first, second, third, or the like, to describe components/elements/steps is for the purposes of this description and should not be construed as sequential ordering/placement/occurrence unless specified otherwise.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

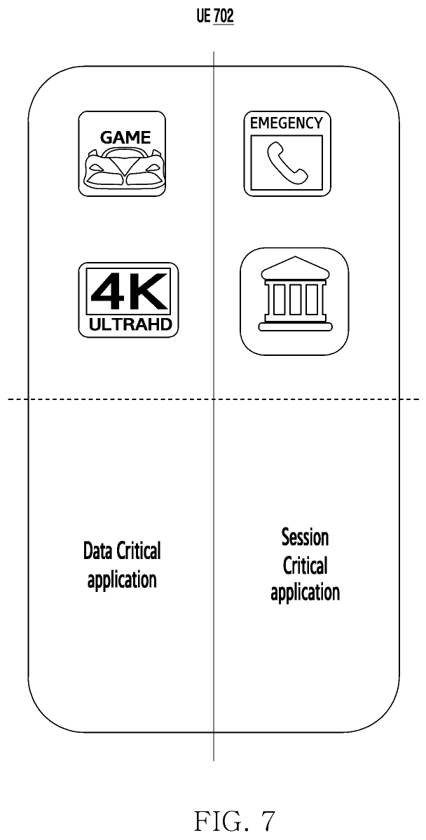

The embodiments herein achieve systems and methods to maintain service session continuity in a wireless communication network. Referring now to the drawings, and more particularly to FIGS. 7, 8A, 8B, 9 to 11, 12A, 12B, and 13, where similar reference characters denote corresponding features consistently throughout the figures, there are shown at least one embodiment.

The URSP rule comprises a rule priority, a traffic descriptor (TD), and a route selection descriptor (RSD). The rule priority determines the execution order of each URSP rule. The traffic descriptor (TD) matches application traffic parameters and selects appropriate route selection parameters. Some of the example of traffic descriptors are App ID, DNN, single-network slice selection assistance information (S-NSSAIs) (network slice), and the like. The application traffic may choose and execute corresponding route selection parameters to route the particular application traffic, only if the application traffic matches with all the parameters of a particular TD. The route selection descriptor (RSD) is a set of parameters to establish a PDU session. The RSD also contains an RSD priority value which decides the execution order of RSDs. The RSD along with the RSD priority also contains with PDU session attributes, such as S-NSSAI (network slice), DNN, service session continuity (SSC) mode and the like.

The URSP rule is defined in 3GPP TS 23.503, and is a set of one or more URSP rules. A URSP rule comprises a precedence value of the URSP rule identifying the precedence of the URSP rule among all the existing URSP rules, wherein the precedence value is also known as the rule priority.

Further, the URSP rule is includes a traffic descriptor and one or more route selection descriptors. The traffic descriptor, includes but is not limited to, a match all traffic descriptor. The URSP rule with the match all Traffic descriptor routes the traffic of applications, which does not match any other URSP rule. Therefore, the match all traffic descriptor shall be evaluated as the last URSP rule, i.e., with the lowest priority. There shall be only one RSD in the URSP rule having match all traffic descriptor. The traffic descriptor may or else include, but is not limited to
one or more application identifiers;
one or more IP 3 tuples as defined in 3GPP TS 23.503, i.e., the destination IP address, the destination port number, and the protocol in use above the internet protocol (IP);
one or more non-IP descriptors, i.e., destination information of non-IP traffic;
one or more data network name (DNNs);
one or more connection capabilities;
one or more domain descriptors, i.e., destination FQDN(s) or a regular expression as a domain name matching criteria; and
one or more route selection descriptors each comprising of the rule priority value of the route selection descriptor.

The traffic descriptor may also include one of a PDU session type and, optionally, one or more of an SSC mode, and a NSSAI. In an embodiment of the disclosure, if the URSP rule is a part of a non-subscribed standalone non-public network (SNPN) signalled URSP, the S-NSSAI is one of the non-subscribed SNPN otherwise the S-NSSAI is of the home public land mobile network (HPLMN), or the subscribed SNPN. A mapped HPLMN slice service type (SST) and mapped HPLMN slice differentiator (SD) may not be included in the S-NSSAI. The traffic descriptor may also include one of the DNN, void, preferred access type, multi-access preference, a time window, a location criterion, a PDU session pair ID, a retransmission sequence number (RSN), a non-seamless non-3GPP offload indication, or a 5G ProSe layer-3 UE-to-network relay offload indication.

In an embodiment of the disclosure, only one URSP rule in the URSP can be a default URSP rule and the default URSP rule shall contain a match all traffic descriptor. If a default URSP rule and one or more non-default URSP rules are included in the URSP, any non-default URSP rule shall have a lower precedence value than (i.e., shall be prioritised over) the default URSP rule.

FIG. 7 shows a schematic diagram showing identification of the application type of the application running on the UE, according to an embodiment of the disclosure.

Referring to FIG. 7, in an embodiment of the disclosure, if a traffic descriptor lists one or more application identifiers together with one or more connection capabilities, a UE 702 shall use the application identifiers to identify the applications requesting access to the connection capabilities.

In an embodiment of the disclosure, the UE 702 may re-evaluate the URSP rules, to check if the change of the association of an application to a PDU session is needed. The implementation of the UE 702 can determine the time when the UE 702 performs the re-evaluation. The UE 702 may perform the re-evaluation in a timely manner. The UE 702 may perform the URSP re-evaluation on the following conditions:
the UE 702 performs periodic URSP rules re-evaluation based on UE 702 implementation;
the UE 702 network access stratum (NAS) layer indicates that an existing PDU session used for routing traffic of an application based on a URSP rule is released;
the URSP is updated by the policy control function (PCF);
the UE 702 NAS layer indicates that the UE 702 performs inter-system change from S1 mode to N1 mode;
the UE 702 NAS layer indicates that the UE 702 is successfully registered in N1 mode over 3GPP access or non-3GPP access;
the UE 702 establishes or releases a connection to a wireless local area network (WLAN) access and transmission of a PDU of the application via non-3GPP access outside of a PDU session becomes available/unavailable;
the allowed NSSAI or the configured NSSAI is changed; or
the LADN information is changed.

Embodiments herein disclose methods and systems for maintaining service session continuity in a wireless communication network by triggering corresponding URSP rule re-evaluation only after the corresponding session or service has been stopped/ended, where the service session continuity is most important. In another scenario, the URSP rule re-evaluation may be triggered based on application traffic or requirement, whenever applicable during the session to always avail the better PDU session attributes, for example, network slice, DNN, and so on.

Embodiments herein disclose methods and systems for maintaining service session continuity in a wireless communication network by establishing higher quality, higher bandwidth, and lower latency data path, wherever applicable. The method comprises identifying a type of an application running on a device, or the UE 702. The method comprises identifying a corresponding PDU Session mapping for the application data route. The method further comprises deferring re-evaluation of the URSP, until the current service session is over based on the type of application, until at least one condition has been met. The method further comprises triggering URSP re-evaluation only after the current service session is over, and triggering re-evaluation and applying highest priority URSP rules for the current application traffic during the ongoing data session based on the application type to guarantee the provide best service availability.

Embodiments herein define the right triggers and times to re-evaluate the URSP rules for the UE 702. The time to trigger the re-evaluation of the URSP rule may be different for different application types. As per the proposed solution, in an embodiment of the disclosure, the UE 702 may understand the application type. For example, the application type of the application can be a session critical application, a service critical application, data critical application, or the like. Based on the application type, the UE 702 may decide when to re-evaluate a particular URSP rule. In an embodiment of the disclosure, the UE 702 may re-evaluate the URSP rule on demand based on application need. In other words, re-evaluation of the entire URSP rule set might not be needed and can be decided to partly re-evaluate URSP rules based on a need to run a specific application. In an embodiment of the disclosure, the UE 702 may choose to defer re-evaluation of the URSP rule for session critical applications, such as voice calls, video calls, emergency calls, banking transactions, online gaming, artificial intelligence (AI) assisted medical assistance, extended reality (XR) applications, or the like. For these applications, the UE 702 may defer URSP re-evaluation until one of the following conditions has been met:
an on-going activity (call) ends,
until the existing PDU is released by the network,
until the UE 702 implement timer expires for deferring the re-evaluation for a specific App ID for t seconds, or
until the UE 702 moves to an idle state.

In an embodiment of the disclosure, for data critical or service critical applications (for example, online streaming apps like Netflix™, YouTube™, Hotstar™, or the like), the UE 702 may re-evaluate the URSP rule as soon as a new URSP re-evaluation is available. The URSP rule can be re-evaluated immediately to always get a best available service, i.e., a best available slice and a DNN combination.

In an embodiment of the disclosure, if the UE 702 is working in service and sessions continuity mode 3 (SCC mode 3), the network ensures that the UE 702 suffers no loss of connectivity, when the PDU session anchor user plane function (PSA UPF) change takes place. In SCC mode 3, the UE 702 may establish a PDU session before releasing an existing PDU session, i.e., call continuity or session continuity is guaranteed. If the UE 702 is working in SCC mode 3, the UE 702 may re-evaluate URSP rules immediately irrespective of the application type.

In an embodiment of the disclosure, the UE 702 may identify the type of application based on the application requirement and group the applications based on the identified application type.

The applications may be categorized as a data critical application, or a session critical application, based on the application requirement. The UE 702 may use identifying and grouping algorithms t including AI machine learning (ML) based algorithms to identify the application type and grouping the application based on the identified application type. The algorithms to identify the application type and group the applications may include at least one of, but is not limited to fuzzy logic, independent component analysis, least squares method, deep learning, adaptive control systems, convolutional neural network, blind identification, identification model. The algorithms are selected taking into account the running application, identifying the type of Quality of Service used by the application, app store classification of applications and categorization of the application from the user. Continuity of the service session is important for session critical applications and has a direct user experience impact. If the service session is interrupted, the current session may fail and cause reconnection issues. For example, if an ongoing banking session (where the banking application can be a session critical application) is interrupted, the banking transaction may fail. Sometimes, money may be deducted from a user account of an owner of the UE 702, even though the transaction is shown as failed by the banking application.

Applications supporting voice call, video call, emergency services, banking applications, live or online gaming applications can be grouped as session critical applications. The applications that mainly deals with data and having a certain data rate, bandwidth or latency requirements can be grouped as data critical applications. Applications, such as streaming applications (e.g., Netflix, Hotstar, or the like), social networking applications (e.g., Facebook, WhatsApp, or the like) may be grouped as data critical applications. Based on the application type, the UE 702 may then apply the URSP rule re-evaluation technique(s). In an embodiment of the disclosure, applications that offer social networking as well as calling facilities like voice call, video call and group call may be categorized according to the services offered by the application at the point of time. For example, application like WhatsApp can be grouped in both the categories i.e., data critical and session critical based on the current user activity. For example, if WhatsApp is used for chatting only, then the application is data critical. If WhatsApp is used for voice call, video call, group call, then the application is session critical.

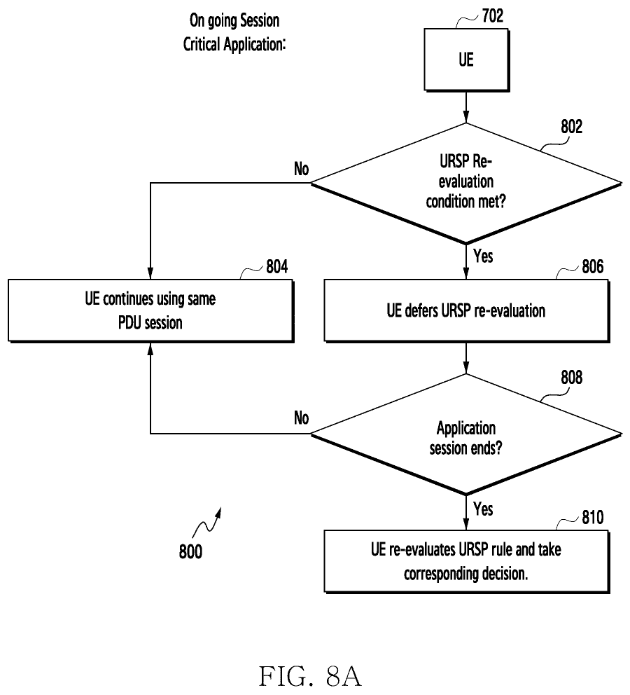

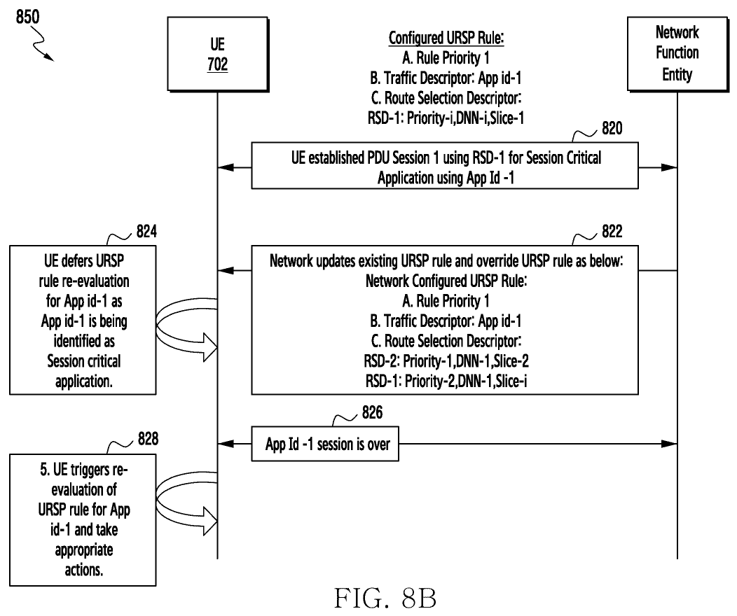

FIG. 8A depicts a method 800 for re-evaluating URSP rules for session critical applications, after the session is over according to an embodiment of the disclosure.

Referring to FIG. 8A, at operation 802, the UE 702 checks if the URSP re-evaluation criteria has been met for the session critical application running on the UE 702. At operation 804, if the URSP re-evaluation criteria has not been met, the UE 702 may continue using the old PDU session. At operation 806, for a session critical application, if the URSP re-evaluation criteria has been met, the UE 702 may defer re-evaluating the URSP, and wait until the ongoing session critical application session is over. At operation 808, the UE 702 checks continuously if the ongoing session critical application session has ended. At operation 810, on completion of the current ongoing session of the session critical application, the UE 702 may trigger the URSP re-evaluation and update the URSP rule for the corresponding session critical application. This ensures an uninterrupted session continuity for the session critical application, therefore avoiding session failures during the ongoing session. For example, during an ongoing banking session, the UE 702 may defer the re-evaluation of the URSP rule. Therefore, the banking session is not interrupted, and the transaction is completed. Once the transaction has been completed, the UE 702 determines that the session is complete, and triggers the new URSP rule to be re-evaluated. The old PDU session for the banking service may be released, on completion of the banking session, and a new PDU session being established.

In an embodiment of the disclosure, during an ongoing session critical application, if at least one URSP re-evaluation criteria has been met, the UE 702 will defer the execution of re-evaluating URSP rules for session critical applications. The UE 702 will continue using the existing PDU session for the session critical application. The UE 702 may trigger re-evaluation of the URSP rule for session critical application once the application session has ended, e.g., the voice or video or emergency call has ended. Therefore, the UE 702 ensures that it follows the updated URSP rule for the next session onwards. Therefore, the current application session may not be interrupted. Hence, the UE 702 does not face any voice, video or emergency call drop, or any critical error(s) while performing important transactions (such as banking transactions, or the like).

FIG. 8B depicts a method 850 for re-evaluating URSP rules for session critical applications, according to an embodiment of the disclosure. For example, considering that the URSP rule evaluation criteria has been met, and the UE 702 finds an updated URSP rule configured as follows:
Rule priority: 1
Traffic descriptor: App ID-1
Route selection descriptor: RSD-1: Priority-1, DNN-1, Slice-1

Referring to FIG. 8B, at operation 820, the UE 702 had previously established a PDU Session with session id 1 using RSD-1 for session critical applications (e.g., voice, video, emergency calls) using App ID-1. At operation 822, the network updates the existing URSP rule and overrides the URSP rule as below:
Rule priority: 1
Traffic descriptor: App ID-1
Route selection descriptor: RSD-2: Priority-1, DNN-1, Slice-2, RSD-1: Priority-2, DNN-1, Slice-1.

At operation 824, during an ongoing service session, the UE 702 defers the URSP rule re-evaluation for App ID-1, as App ID-1 is identified as a session critical application. At operation 826, the UE 702 checks is the App ID-1 session is over, and on determining that the ongoing session for App ID-1 is over, the UE 702 triggers re-evaluation of URSP rules for App ID-1 and takes appropriate actions. The UE 702 may release the old PDU session and establish the new PDU session with the updated URSP rules.

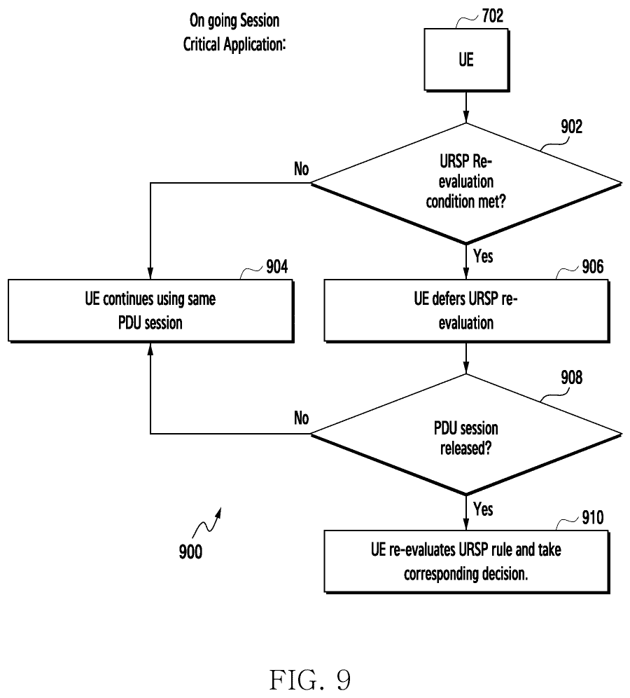

FIG. 9 depicts a method 900 for re-evaluating URSP rules for session critical applications, after the PDU session has been released, according to an embodiment of the disclosure.

When a session critical application is ongoing, if at least one URSP re-evaluation criteria has been met, the UE 702 may defer the execution of re-evaluating URSP rules for session critical applications. The UE 702 may continue using the existing PDU session for the session critical application. The UE 702 may trigger the URSP rule re-evaluation for the session critical application, once the PDU session has been released by the network or the UE 702. Therefore, this ensures that the UE 702 follows the correct URSP rule until the current PDU session is active. Therefore, the current application session will not be dropped. Hence, the UE 702 may not face any voice, video or emergency call drop or any critical error while performing important transactions (such as banking transactions, or the like) and call drops.

Referring to FIG. 9, in an embodiment of the disclosure, at operation 902, the UE 702 checks if at least one URSP re-evaluation criteria has been met for an ongoing session critical application, if the URSP re-evaluation criteria has not been met, in operation 904, the UE 702 may continue with the ongoing PDU session. If the URSP re-evaluation criteria has been met, and a new URSP rule is available for upgrading the service quality, in operation 906, the UE 702 may defer the URSP re-evaluation for the ongoing service session for the application, as the application is a session critical application. At operation 908, the UE 702 checks if the current PDU session has been released by the network or the UE. If the current PDU session has been released, in operation 910, the UE 702 may trigger the re-evaluation of the URSP rules for the current session critical application. Therefore, there may not be any interruption in the services for the session critical application. Thus, the URSP rules may get re-evaluated to the updated URSP rules for upgraded services without interrupting the services of the ongoing session critical

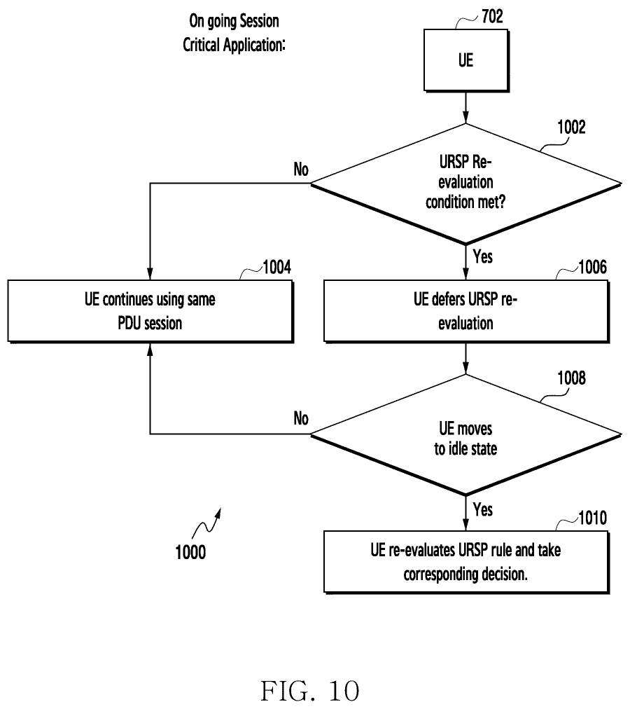

FIG. 10 depicts a method 1000 for re-evaluating URSP rules for session critical applications, after a UE has moved to an idle state, according to an embodiment of the disclosure.

During the ongoing session critical application, if at least one URSP re-evaluation criteria has been met, the UE 702 may defer the execution of re-evaluating URSP rules for session critical applications. The UE 702 may continue using the existing PDU session for the session critical application. The UE 702 may trigger the URSP rule re-evaluation for session critical applications, once the UE 702 has moved to an idle state, i.e., for example, MM idle or RRC Release. The UE 702 may be in 5GMM-idle mode over non-3GPP access when there is no N1 network access stratum (NAS) signal connection between the UE 702 and the network over non-3GPP access. The radio resource control (RRC) release refers to the procedure by which an established RRC connection between the UE 702 and a gNB (gNodeB) is released. Therefore, the UE 702 may follow the current URSP rule until the current RRC or EMM session is active. Therefore, the current application session may not be dropped for the session critical application. Hence, the UE 702 will not face any voice, video or emergency call drop and any critical error while performing important transactions (such as banking transactions, or the like).

Referring to FIG. 10, in an embodiment of the disclosure, at operation 1002, the UE 702 may check for if the URSP re-evaluation criteria has been met for an ongoing session critical application. At operation 1004, if the URSP re-evaluation criteria has not been met, the UE 702 may continue with the ongoing PDU session. At operation 1006, in case if the URSP re-evaluation criteria has been met, and a new URSP rule is available for upgrading the service quality, the UE 702 may defer the re-evaluation of the URSP for the ongoing service session for the application, as the application is a session critical application. At operation 1008, the UE 702 checks if the current RRC or EMM session is active, or the UE 702 has moved to idle state, for e.g., MM idle or RRC release state. If the UE 702 is not in idle state, the UE 702 continues with the current PDU session. At operation 1010, if the UE 702 has moved to idle state, the UE 702 may trigger the Re-evaluation of the URSP for the current session critical application. Therefore, there may not be any interruption in the services for the session critical application. Thus, the URSP rules may get re-evaluated to the updated URSP rules for upgraded services without interrupting the services of the ongoing session critical

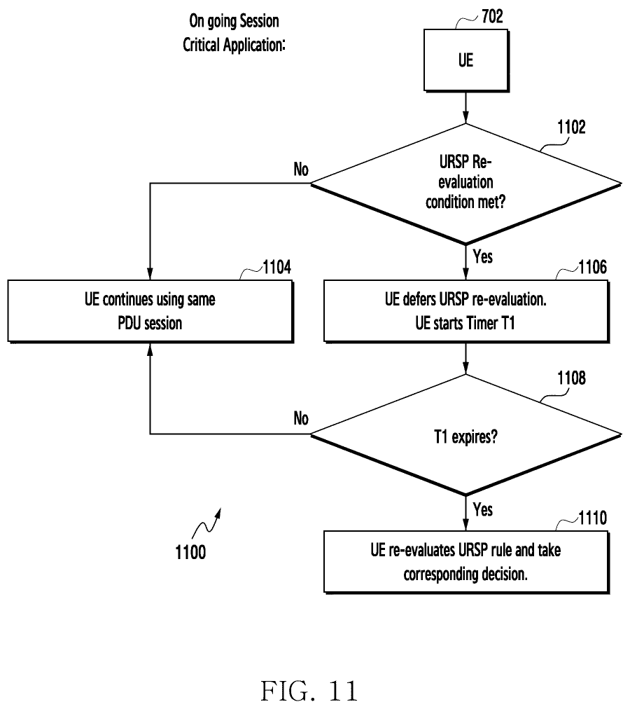

FIG. 11 depicts a method 1100 for re-evaluating URSP rules for session critical applications, after a timer expires, according to an embodiment of the disclosure.

When a session critical application is ongoing, if any of URSP re-evaluation criteria has been met, the UE 702 will defer the execution of re-evaluating URSP rules for session critical applications. The UE 702 will the start timer (e.g., T1) at this point until which the UE 702 will not re-evaluate the URSP rule for the current application. The UE 702 will continue using the existing PDU session for the session critical application. The UE 702 will trigger the URSP rule re-evaluation for session critical applications, once the timer T1 has expired. Optionally, the UE 702 may keep on restarting the timer optionally with incremental values, if the current session for the application is not over yet. Therefore, the UE 702 may follow the updated URSP rule after the timer expires. Therefore, the current application session may not be interrupted. For example, an ongoing call may not be dropped in between due to re-evaluation of the URSP. Hence, the UE 702 will not face any voice, video or emergency call drop or any critical error while performing important transactions (such as banking transactions, or the like).

Referring to FIG. 11, in an embodiment of the disclosure, at operation 1102, the UE 702 may check for if the URSP re-evaluation criteria has been met for an ongoing session critical application. At operation 1104, if the URSP re-evaluation criteria has not been met, the UE 702 may continue with the ongoing PDU session. At operation 1106, in case if the URSP re-evaluation criteria has been met, and a new URSP rule is available for upgrading the service quality, the UE 702 may defer the Re-evaluation of the URSP for the ongoing service session for the application, as the application is the session critical application. the UE 702 will the start timer (e.g., T1) at this point until which the UE 702 will not re-evaluate the URSP rule for the current application. The UE 702 will continue using the existing PDU session for the session critical application. At operation 1108, the UE 702 checks if the timer set to defer the Re-evaluation of the URSP has expired or not. In an embodiment of the disclosure, the UE 702 may keep on restarting the timer optionally with incremental values, if the current session for the application is not over yet. If the timer has not expired, the UE 702 may continue with the current PDU session until the timer expires. At operation 1110, on the completion of the current ongoing session of the session critical application, the UE 702 may trigger the Re-evaluation of the URSP and update the URSP rule for the corresponding session critical application. This ensures an uninterrupted session continuity for the session critical application, therefore avoiding session failures in middle of the ongoing session.

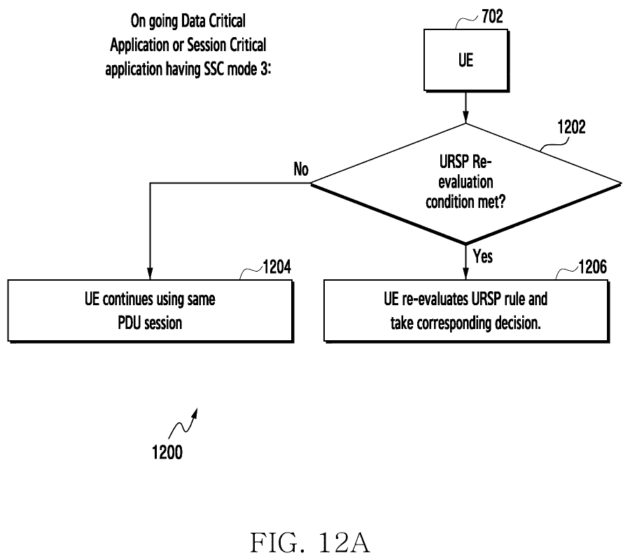

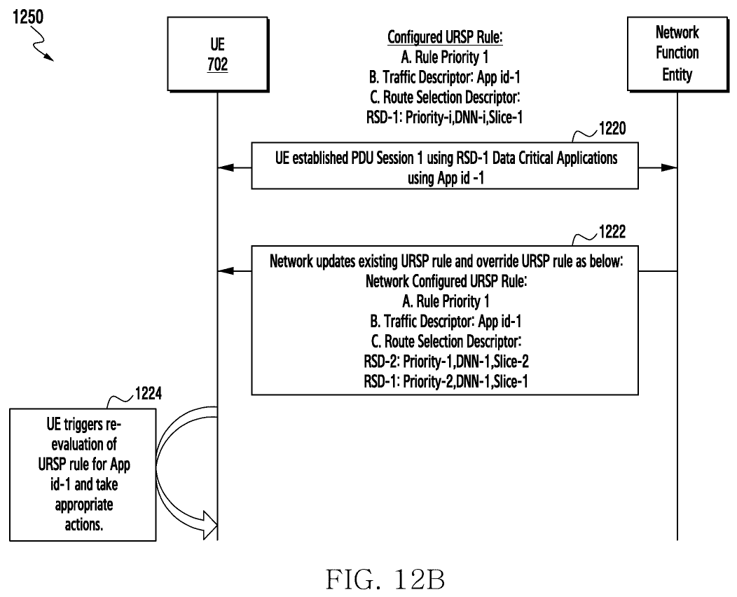

FIG. 12A depicts a method 1200 for re-evaluating URSP rules for data critical applications according to an embodiment of the disclosure.

During a data critical application session, if any of URSP re-evaluation criteria has been met, the UE 702 will re-evaluate the URSP rule.

Referring to FIG. 12A, at operation 1202, the UE 702 checks if the URSP re-evaluation criteria has been met for the data critical application running on the UE 702. At operation 1204, if the URSP re-evaluation criteria has not been met then the UE 702 may continue using the old PDU session. At operation 1206, for the data critical application, if the URSP re-evaluation criteria has been met, the URSP rules are re-evaluated immediately without any delay. Therefore, the data critical applications may get the highest or the top priority URSP rules for data services. For example, if the URSP rule evaluation criteria has been met, and the UE 702 determines that a better-quality slice is available for an ongoing online streaming application. The UE 702 will immediately re-evaluate the URSP rule to enable the online streaming application to have a better-quality network slice for online streaming.

In an embodiment of the disclosure, the method 1200 is also applicable if the UE 702 is currently using the session critical application and the current PDU session is having service session continuity mode 3 (SSC mode 3). With SSC mode 3, changes to the user plane may be visible to the UE 702. The network ensures that the UE 702 suffers no loss of connectivity in SCC mode 3. A connection through the new PDU session is established before the previous connection on the old PDU session is released, in order to allow for better service continuity.

In another embodiment of the disclosure, the UE 702 may check for the quality of service of the new RSD or the PDU session attributes of the URSP rule, whenever the URSP rule is available for re-evaluation. The UE 702 may defer establishing a new PDU session as identified from URSP rule re-evaluation, if the new RSD or PDU session attributes lower the service quality of the application compared to a currently used RSD or PDU session for an ongoing application. The determining of the quality of service provided by the URSP rule can be irrespective of the application type, i.e., it may not take into consideration whether the ongoing application is a session critical application or a data critical application. If the quality of service of the URSP rule is determines, the UE 702 may re-evaluate the URSP rule for the application after the current data session is over or if the UE 702 faces any kind of data stall when using the current PDU session.

FIG. 12B depicts a sequence diagram 1250 for re-evaluating URSP rules for data critical applications according to an embodiment of the disclosure. For example, considering that the URSP rule evaluation criteria has been met and the UE 702 has the URSP rule configured as follows:
Rule priority: 1
Traffic descriptor: App ID-1
Route selection descriptor: RSD-1: Priority-1, DNN-1, Slice-1

Referring to FIG. 12B, at operation 1220, the UE 702 has established a PDU session ID 1 using RSD-1 for an online streaming application using App ID-1. At operation 1222, the network updates the existing URSP rule and overrides the URSP rule as below:
Rule priority: 1
Traffic descriptor: App ID-1
Route selection descriptor:
RSD-2: Priority-1, DNN-1, Slice-2
RSD-1: Priority-2, DNN-1, Slice-1.

The UE 702 may have already determined that the application type is a data critical service before the checking for the URSP rule evaluation criteria has been met or not. The application type is a data critical service that will always opt for a better quality network slice for the data streaming, because higher quality of data ensures maximum data speed as well as a better quality network slice, for e.g., 4k streaming. Therefore, at operation 1224, the UE 702 triggers re-evaluation of the URSP rule for App ID-1 and take appropriate actions. The UE 702 may release the old PDU session and establish a new PDU session with the updated URSP rules.

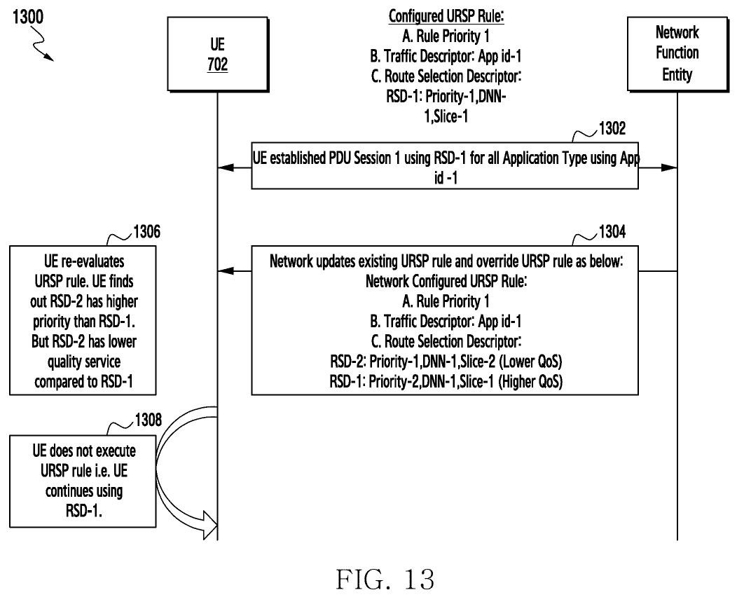

FIG. 13 depicts a scenario 1300 showing a UE 702 determining the quality of service (QOS) for each URSP rule is identified and execution of the URSP rule, according to an embodiment of the disclosure. For example, considering that the URSP rule evaluation criteria has been met, and the UE 702 has the URSP rule configured as follows:
Rule priority: 1
Traffic descriptor: App ID-1
Route selection descriptor: RSD-1: Priority-1, DNN-1, Slice-1

Referring to FIG. 13, at operation 1302, the UE 702 may already have an established PDU Session ID 1 using RSD-1 for voice/video/emergency call using App ID-1. At operation 1304, the network updates the existing URSP rule and overrides the URSP rule as below:
Rule priority: 1
Traffic descriptor: App ID-1
Route selection descriptor: RSD-2: Priority-1, DNN-1, Slice-2
RSD-1: Priority-2, DNN-1, Slice-1

The UE 702 identifies that the RSD-2 parameters provide a lower QoS, i.e., Slice-2 has a lower quality slice and RSD-1 parameters provides a higher QoS, i.e., slice-1 has a higher quality slice. At operation 1306, the UE 702 re-evaluates the URSP rule. The UE 702 identifies that the RSD-2 has a higher priority than the RSD-1. However, the UE 702 also determines that RSD-2 has a lower quality service compared to RSD-1. Therefore, at operation 1308, the UE 702 does not execute the new URSP rule, i.e., the UE 702 continues using RSD-1. The QoS may be degraded by network for all types of applications i.e., data critical application and session critical application.

According to embodiments, a method to maintain service session continuity in a wireless communication network is provided. The method comprises identifying, by a user equipment (UE), an application running on the UE and a corresponding packet data unit (PDU) session mapping for an application data route, deferring, by the UE, re-evaluation of UE route selection policy (URSP), until at least one condition has been met, based on an application type, and triggering, by the UE, re-evaluation and applying highest priority URSP rules for traffic, for the identified application, based on the application type.

For example, the method comprises determining, by the UE, if at least one of a URSP re-evaluation criteria has been met. The URSP re-evaluation criteria comprises at least one of a URSP rule priority, a traffic descriptor, or a route selection descriptor.

For example, the method comprises grouping, by the UE, the identified application into at least one group based on the application type of the identified application. The application type comprises at least one of a data critical application or a session critical application.

For example, the data critical application comprises applications dealing with data and having a certain data rate, and a throughput requirement. Data critical applications comprises at least one of streaming applications or social networking applications.

For example, the session critical application comprises applications requiring uninterrupted service session continuity, a latency requirement and having direct user experience impact. Session critical applications comprises at least one of a voice call, a video call, an emergency service, or any real time applications including at least one of a banking application or an online multiplayer gaming application.

For example, URSP re-evaluation is deferred, if the application type is the session critical application.

For example, the method comprises triggering, by the UE, URSP re-evaluation immediately, if the application type is the data critical application.

For example, the method comprises performing at least one of triggering, by the UE, URSP re-evaluation after a current session is over, if the application type is the session critical application; or triggering, by the UE, the URSP re-evaluation on facing a data stalling in between an ongoing PDU session, irrespective of the application type.

For example, the method comprises triggering, by the UE, URSP re-evaluation immediately irrespective of the application type, if a corresponding PDU session is a service and session continuity mode 3 (SCC mode 3).

For example, the at least one condition comprises at least one of an ending of an ongoing service session, releasing of an existing PDU session, expiring of a UE implementation timer, or the UE moving to an idle state.

For example, the method comprises identifying, by the UE, one of a new route selection descriptor (RSD) or a PDU session attribute of a new URSP rule based on re-evaluating the URSP rule and deferring, by the UE, establishment of a new PDU session, on identifying one of the RSD or the PDU session attribute of the new URSP rule lowers a quality of service (QOS) of the application.

According to embodiments, a user equipment (UE) in a wireless communication system is provided. The UE comprises a transceiver, memory storing one or more computer programs, and one or more processors communicatively coupled to the transceiver and the memory. The one or more computer programs include computer-executable instructions that, when executed by the one or more processors, cause the UE to identify an application running on the UE and a corresponding packet data unit (PDU) session mapping for an application data route, defer a re-evaluation of UE route selection policy (URSP), until at least one condition has been met, based on an application type, and trigger the re-evaluation and applying highest priority URSP rules for traffic for the identified application during an ongoing service session based on the application type.

According to embodiments, a method to maintain a service session continuity, in a wireless communication system is provided. The method comprises identifying, by a user equipment (UE), an application type and a corresponding packet data unit (PDU) session mapping for an application data route for an application running on the UE; deferring, by the UE, UE route selection policy (URSP) re-evaluation until at least one of a condition to initiate the URSP re-evaluation has been met; and triggering, by the UE, the URSP re-evaluation, based on the identified application type for the application running on the UE.

For example, the method comprises applying highest priority URSP rules for traffic, for the application, based on the identified application type.

For example, a highest priority URSP rules comprises establishing a higher quality, a higher bandwidth and lower latency data path for the application data route.

For example, a highest priority URSP rules comprises a rule priority for determining an execution order of each URSP rules, a traffic descriptor (TD) for matching an application traffic parameter and then selecting route selection parameters, based on the matching of the traffic descriptor, and a route selection descriptor (RSD) comprising a set of parameters to establish a PDU session, an RSD priority value and PDU Session attributes.

According to embodiments, a user equipment (UE) in a wireless communication system is provided. The UE comprises a transceiver; memory storing one or more computer programs; and one or more processors communicatively coupled to the transceiver and the memory. The one or more computer programs include computer-executable instructions that, when executed by the one or more processors, cause the UE to identify, an application type and a corresponding packet data unit (PDU) session mapping for an application data route for an application running on the UE, defer, UE route selection policy (URSP) re-evaluation until at least one of a condition to initiate the URSP re-evaluation has been met, and trigger, the URSP re-evaluation, based on the identified application type for the application running on the UE.

For example, the one or more computer programs further include computer-executable instructions that, when executed by the one or more processors, cause the UE to determine, by the UE, if at least one of a URSP re-evaluation criteria has been met. The URSP re-evaluation criteria comprises at least one of a URSP rule priority, a traffic descriptor, or a route selection descriptor.

According to embodiments, one or more non-transitory computer-readable storage media storing computer-executable instructions that, when executed by one or more processors of a user equipment (UE), cause the UE to perform operations is provided. The operations comprises identifying, by the UE, an application running on the UE and a corresponding packet data unit (PDU) session mapping for an application data route; deferring, by the UE, re-evaluation of UE route selection policy (URSP), until at least one condition has been met, based on an application type; and triggering, by the UE, re-evaluation and applying highest priority URSP rules for traffic, for the identified application, based on the application type.

For example, the operations comprise determining, by the UE, if at least one of a URSP re-evaluation criteria has been met. The URSP re-evaluation criteria comprises at least one of a URSP rule priority, a traffic descriptor, or a route selection descriptor.

According to embodiments, a method to maintain service session continuity in a wireless communication network is provided. The method comprises identifying, by a user equipment (UE), an application running on the UE and a corresponding packet data unit (PDU) session for an application data route; deferring, by the UE, re-evaluation of one or more UE route selection policy (URSP) rules, until at least one condition has been met, based on an application type of the application; and triggering, by the UE, the re-evaluation of one or more URSP rules and applying a highest priority URSP rule for traffic for the identified application.

For example, the one or more URSP rules are updated while the application is running over the PDU session. The re-evaluation of the updated one or more URSP rules is deferred in case that the application type is a session critical application and a service and session continuity mode (SCC mode) of the corresponding PDU session is not a SCC mode 3.

For example, the method comprises determining, by the UE, whether at least one of a URSP re-evaluation criteria has been met. The URSP re-evaluation criteria comprises at least one of a URSP rule priority, a traffic descriptor, or a route selection descriptor. The application type comprises at least one of a data critical application or a session critical application.

For example, the data critical application comprises applications dealing with data and having a certain data rate, and a throughput requirement. The data critical application comprises at least one of streaming applications or social networking applications.

For example, the session critical application comprises applications requiring uninterrupted service session continuity, a latency requirement and having direct user experience impact. The session critical application comprises at least one of a voice call, a video call, an emergency service, or any real time applications including at least one of a banking application or an online multiplayer gaming application.

For example, the re-evaluation is deferred in case that the application type is the session critical application.

For example, the method comprises triggering, by the UE, the re-evaluation immediately, in case that the application type is the data critical application.

For example, the method comprises performing at least one of triggering, by the UE, the re-evaluation after a current session is over, if the application type is the session critical application; or triggering, by the UE, the re-evaluation on facing a data stalling in between an ongoing PDU session, irrespective of the application type.

For example, the method comprises triggering, by the UE, the re-evaluation immediately irrespective of the application type, if the corresponding PDU session is a service and session continuity mode 3 (SCC mode 3).

For example, the at least one condition comprises at least one of an ending of an ongoing service session, releasing of an existing PDU session, expiring of a UE implementation timer, or the UE moving to an idle state.

For example, the method comprises identifying, by the UE, one of a new route selection descriptor (RSD) or a PDU session attribute of a new URSP rule based on the re-evaluation; and deferring, by the UE, establishment of a new PDU session, on identifying one of the RSD or the PDU session attribute of the new URSP rule lowers a quality of service (QOS) of the application.

According to embodiments, a user equipment (UE) in a wireless communication system is provided. The UE comprises one or more processors; and memory storing one or more instructions that, when executed by the one or more processors, cause the UE to identify an application running on the UE and a corresponding packet data unit (PDU) session for an application data route, defer a re-evaluation of one or more UE route selection policy (URSP) rules, until at least one condition has been met, based on an application type of the application, and trigger the re-evaluation of one or more URSP rules and applying a highest priority URSP rule for traffic for the identified application.

For example, the one or more URSP rules are updated while the application is running over the PDU session. The re-evaluation of the updated one or more URSP rules is deferred in case that the application type is a session critical application and a service and session continuity mode (SCC mode) of the corresponding PDU session is not a SCC mode 3.

For example, the instructions, when executed by the one or more processors, cause the UE to determine whether at least one of a URSP re-evaluation criteria has been met. The URSP re-evaluation criteria comprises at least one of a URSP rule priority, a traffic descriptor, or a route selection descriptor. The application type comprises at least one of a data critical application or a session critical application.

For example, the data critical application comprises applications dealing with data and having a certain data rate, and a throughput requirement. The data critical application comprises at least one of streaming applications or social networking applications.

For example, the session critical application comprises applications requiring uninterrupted service session continuity, a latency requirement and having direct user experience impact. The session critical application comprises at least one of a voice call, a video call, an emergency service, or any real time applications including at least one of a banking application or an online multiplayer gaming application.

For example, the instructions, when executed by the one or more processors, cause the UE to trigger the re-evaluation immediately, in case that the application type is the data critical application.

For example, the instructions, when executed by the one or more processors, cause the UE to trigger, by the UE, the re-evaluation after a current session is over, if the application type is the session critical application; or trigger, by the UE, the re-evaluation on facing a data stalling in between an ongoing PDU session, irrespective of the application type.

For example, the at least one condition comprises at least one of an ending of an ongoing service session, releasing of an existing PDU session, expiring of a UE implementation timer, or the UE moving to an idle state.

According to embodiments, one or more non-transitory computer-readable storage media storing computer-executable instructions that, when executed by one or more processors of a user equipment (UE), cause the UE to perform operations is provided. The operations comprises identifying, by a user equipment (UE), an application running on the UE and a corresponding packet data unit (PDU) session for an application data route; deferring, by the UE, re-evaluation of one or more UE route selection policy (URSP) rules, until at least one condition has been met, based on an application type of the application; and triggering, by the UE, the re-evaluation of one or more URSP rules and applying a highest priority URSP rule for traffic to the identified application.

Embodiments herein address the issue of voice, video or emergency call discontinuity and critical application data session discontinuity by identifying voice, video, emergency or session critical application traffic and defers re-evaluation of the URSP rule, until the at least one of the conditions met. The at least one condition may include but is not limited to ending of current application session, a release of PDU session, when a UE 702 moves to idle state, until a set timer expires. Similarly, embodiments herein also optimize and choose the best data service possible for an identified application by triggering URSP rule re-evaluation, wherever applicable.

The embodiments disclosed herein can be implemented through at least one software program running on at least one hardware device and performing network management functions to control the elements. The elements can be at least one of a hardware device, or a combination of hardware device and software module.

The embodiment disclosed herein describes methods and user equipment for selection of non-terrestrial networks in a wireless communication environment. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high-speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an application specific integrated circuit (ASIC), or a combination of hardware and software means, e.g., an ASIC and a field programmable gate arrays (FPGA), or at least one microprocessor and memory with software modules located therein. The method embodiments described herein could be implemented partly in hardware and partly in software. Alternatively, the disclosure may be implemented on different hardware devices, e.g., using a plurality of central processing units (CPUs).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method to maintain service session continuity in a wireless communication network, the method comprising:
identifying, by a user equipment (UE), an application running on the UE and a corresponding packet data unit (PDU) session for an application data route;
deferring, by the UE, re-evaluation of one or more UE route selection policy (URSP) rules, until at least one condition has been met, based on an application type of the application; and
triggering, by the UE, the re-evaluation of one or more URSP rules and applying a highest priority URSP rule for traffic for the identified application.

2. The method of claim 1,
wherein the one or more URSP rules are updated while the application is running over the PDU session, and
wherein the re-evaluation of the updated one or more URSP rules is deferred in case that the application type is a session critical application and a service and session continuity mode (SCC mode) of the corresponding PDU session is not a SCC mode 3.

3. The method of claim 1, further comprising:
determining, by the UE, whether at least one of a URSP re-evaluation criteria has been met,
wherein the URSP re-evaluation criteria comprises at least one of a URSP rule priority, a traffic descriptor, or a route selection descriptor, and
wherein the application type comprises at least one of a data critical application or a session critical application.

4. The method of claim 3,
wherein the data critical application comprises applications dealing with data and having a certain data rate, and a throughput requirement, and
wherein the data critical application comprises at least one of streaming applications or social networking applications.

5. The method of claim 3,
wherein the session critical application comprises applications requiring uninterrupted service session continuity, a latency requirement and having direct user experience impact, and
wherein the session critical application comprises at least one of a voice call, a video call, an emergency service, or any real time applications including at least one of a banking application or an online multiplayer gaming application.

6. The method of claim 3, wherein the re-evaluation is deferred in case that the application type is the session critical application.

7. The method of claim 3, further comprising triggering, by the UE, the re-evaluation immediately, in case that the application type is the data critical application.

8. The method of claim 3, further comprising performing at least one of:
triggering, by the UE, the re-evaluation after a current session is over, if the application type is the session critical application; or
triggering, by the UE, the re-evaluation on facing a data stalling in between an ongoing PDU session, irrespective of the application type.

9. The method of claim 3, further comprising:
triggering, by the UE, the re-evaluation immediately irrespective of the application type, if the corresponding PDU session is a service and session continuity mode 3 (SCC mode 3).

10. The method of claim 1, wherein the at least one condition comprises at least one of an ending of an ongoing service session, releasing of an existing PDU session, expiring of a UE implementation timer, or the UE moving to an idle state.

11. The method of claim 1, further comprising:
identifying, by the UE, one of a new route selection descriptor (RSD) or a PDU session attribute of a new URSP rule based on the re-evaluation; and
deferring, by the UE, establishment of a new PDU session, on identifying one of the RSD or the PDU session attribute of the new URSP rule lowers a quality of service (QoS) of the application.

12. A user equipment (UE) in a wireless communication system, the UE comprising:
one or more processors; and
memory storing one or more instructions that, when executed by the one or more processors, cause the UE to:
identify an application running on the UE and a corresponding packet data unit (PDU) session for an application data route,
defer a re-evaluation of one or more UE route selection policy (URSP) rules, until at least one condition has been met, based on an application type of the application, and
trigger the re-evaluation of one or more URSP rules and applying a highest priority URSP rule for traffic for the identified application.

13. The UE of claim 12,
wherein the one or more URSP rules are updated while the application is running over the PDU session, and
wherein the re-evaluation of the updated one or more URSP rules is deferred in case that the application type is a session critical application and a service and session continuity mode (SCC mode) of the corresponding PDU session is not a SCC mode 3.

14. The UE of claim 12, wherein the instructions, when executed by the one or more processors, cause the UE to determine whether at least one of a URSP re-evaluation criteria has been met,
wherein the URSP re-evaluation criteria comprises at least one of a URSP rule priority, a traffic descriptor, or a route selection descriptor, and
wherein the application type comprises at least one of a data critical application or a session critical application.

15. The UE of claim 14,
wherein the data critical application comprises applications dealing with data and having a certain data rate, and a throughput requirement, and
wherein the data critical application comprises at least one of streaming applications or social networking applications.

16. The UE of claim 14,
wherein the session critical application comprises applications requiring uninterrupted service session continuity, a latency requirement and having direct user experience impact, and
wherein the session critical application comprises at least one of a voice call, a video call, an emergency service, or any real time applications including at least one of a banking application or an online multiplayer gaming application.

17. The UE of claim 14, wherein the instructions, when executed by the one or more processors, cause the UE to trigger the re-evaluation immediately, in case that the application type is the data critical application.

18. The UE of claim 14, wherein the instructions, when executed by the one or more processors, cause the UE to:
trigger, by the UE, the re-evaluation after a current session is over, if the application type is the session critical application; or
trigger, by the UE, the re-evaluation on facing a data stalling in between an ongoing PDU session, irrespective of the application type.

19. The UE of claim 12, wherein the at least one condition comprises at least one of an ending of an ongoing service session, releasing of an existing PDU session, expiring of a UE implementation timer, or the UE moving to an idle state.

20. One or more non-transitory computer-readable storage media storing computer-executable instructions that, when executed by one or more processors of a user equipment (UE), cause the UE to perform operations, the operations comprising:
identifying, by a user equipment (UE), an application running on the UE and a corresponding packet data unit (PDU) session for an application data route;
deferring, by the UE, re-evaluation of one or more UE route selection policy (URSP) rules, until at least one condition has been met, based on an application type of the application; and
triggering, by the UE, the re-evaluation of one or more URSP rules and applying a highest priority URSP rule for traffic to the identified application.
